(19) United States
(12) Patent Application Publication
(10) Pub. No.: US 2026/0236219 A1
(43) Pub. Date: Aug. 13, 2026

(54) THE MULTIPLE-AUDIO-SOURCE ADAPTIVE SWITCHING DEVICE AND METHOD THEREOF

(71) Applicant: REALTEK SEMICONDUCTOR CORP., HsinChu (TW)

(72) Inventors: Jin-Hui WEI, HsinChu (TW); Hong CHANG, HsinChu (TW); Tao XU, HsinChu (TW); Zhe XU, HsinChu (TW)

(73) Assignee: REALTEK SEMICONDUCTOR CORP., HsinChu (TW)

(21) Appl. No.: 19/536,441

(22) Filed: Feb. 11, 2026

(30) Foreign Application Priority Data
Feb. 12, 2025 (CN) 202510154075.3

(51) Int. Cl. G06F 3/16

(52) U.S. Cl. CPC G06F 3/165

(57) ABSTRACT

A multiple-audio-source adaptive switching device and a method thereof are provided. The method includes: receiving the audio signal; extracting a plurality of sampling points from the audio signal, where one of the sampling points is defined as the first sampling point, and the rest of the sampling points are defined as a plurality of second sampling points; in response to that an absolute difference between each of the second sampling points and the first sampling point is determined to be greater than the first threshold value, accumulating the effective value to obtain an accumulated value; and in response to that the accumulated value is determined to be greater than the second threshold value, outputting the audio signal.

### CROSS-REFERENCE TO RELATED APPLICATION

This non-provisional application claims priority under 35 U.S.C. § 119(a) to Patent Application No. 202510154075.3 filed in China, P.R.C. on February 12, 2025, the entire contents of which are hereby incorporated by reference.

### BACKGROUND

### Technical Field

The instant disclosure relates to an audio device and method, and in particular to a device and method suitable for executing audio detection.

### Related Art

As known to the inventor, multi-picture display devices mostly allow a user to play a specific audio through manual switching. For example, the user may manually switch various audio signal sources through an on-screen display (OSD) menu of the display; alternatively, the user may switch the audio signal sources through software setting; yet alternatively, the user may switch the audio signal sources through a hardware button on the display device.

The operating manner of manual switching is quite intuitive for the user, but there are still some shortcomings. For example, when a plurality of pictures is played through a screen of the same display, a screen menu sets a specific picture among the pictures as the audio source; however, this specific picture in fact does not contain audio play requirement in the moment. Next, in response to that another picture contains a call request or another information notification tone, the user has to perform manual switching to receive the call request or the notification tone and therefore cannot receive these audio signals in real time. As another example, if the current picture is playing an audio signal, after the user manually switches to another picture processing operation, the display device also cannot switch the audio signal source back to the original picture independently to continue playing. As a result, the user needs to perform manual switching again.

### SUMMARY

In view of this, the applicant provides a multiple-audio-source adaptive switching method, wherein the method comprises: receiving an audio signal; extracting a plurality of sampling points from the audio signal, where one of the sampling points is defined as a first sampling point, and the rest of the sampling points are defined as a plurality of second sampling points; in response to that an absolute difference between each of the second sampling points and the first sampling point is determined to be greater than a first threshold value, accumulating an effective value to obtain an accumulated value; and in response to that the accumulated value is determined to be greater than a second threshold value, outputting the audio signal.

Furthermore, the applicant provides a multiple-audio-source adaptive switching device comprising a multiplexer and an audio detector. The multiplexer is configured to receive a plurality of audio signals and output one of the audio signals; and the audio detector is configured to: receive the one of the audio signals; extract a plurality of sampling points from the one of the audio signals, wherein one of the sampling points is defined as a first sampling point, and the rest of the sampling points are defined as a plurality of second sampling points; in response to that an absolute difference between each of the second sampling points and the first sampling point is determined to be greater than a first threshold value, accumulate an effective value to obtain an accumulated value; and in response to that the accumulated value is determined to be greater than a second threshold value, output the one of the audio signals.

### BRIEF DESCRIPTION OF THE DRAWINGS

The instant disclosure will become more fully understood from the detailed description given herein below for illustration only, and therefore not limitative of the instant disclosure, wherein:

FIG. 1 illustrates a block diagram of a multiple-audio-source adaptive switching system according to some embodiments.

FIG. 2 illustrates a flow chart of a multiple-audio-source adaptive switching method according to some embodiments.

FIG. 3 illustrates a flow chart of steps for detecting audio validity of a multiple-audio-source adaptive switching method according to some embodiments.

FIG. 4A illustrates an oscillogram of temporal data of an audio signal according to some embodiments.

FIG. 4B illustrates an oscillogram of temporal data of an audio signal according to some embodiments after taking absolute value.

FIG. 4C illustrates an oscillogram of temporal data to be sampled of an audio signal according to some embodiments after taking absolute value.

FIG. 5 illustrates a block diagram of a multiple-audio-source adaptive switching system according to some other embodiments.

### DETAILED DESCRIPTION

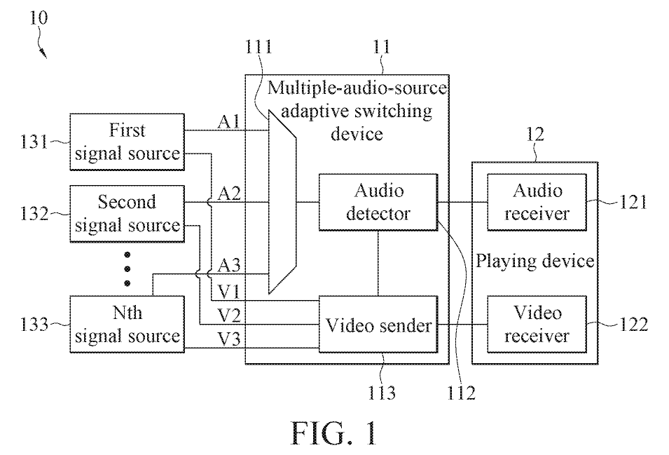

FIG. 1 illustrates a block diagram of the multiple-audio-source adaptive switching system according to some embodiments. Please refer to FIG. 1. In this embodiment, the multiple-audio-source adaptive switching system 10 comprises a multiple-audio-source adaptive switching device 11, a playing device 12, and a plurality of signal sources, i.e., a first signal source 131, a second signal source 132, and an Nth signal source 133. The signal sources are respectively coupled to the multiple-audio-source adaptive switching device 11, and the multiple-audio-source adaptive switching device 11 is coupled to the playing device 12. The coupling mentioned hereinafter allows information transfer between devices, but the coupling is not limited to direct connection or indirect connection through another system, module, device, or element, and the coupling is also not limited to wired connection or wireless connection. In this embodiment, the first signal source 131 sends an audio signal A1 and a video signal V1 to the multiple-audio-source adaptive switching device 11, the second signal source 132 sends an audio signal A2 and a video signal V2 to the multiple-audio-source adaptive switching device 11, and the Nth signal source 133 sends an audio signal A3 and a video signal V3 to the multiple-audio-source adaptive switching device 11.

The signal sources may refer to two or more signal sources; in other words, the Nth signal source 133 in FIG. 1 is not exist when the signal sources refer to two signal sources. The audio signals A1, A2, A3 and the video signals V1, V2, V3 sent by the signal sources correspond to each other. For example, the video signal V1 corresponds to the audio signal A1. For example, the video signal V1 is a picture of a drama, and the audio signal A1 is a sound synchronized with the picture of the drama; alternatively, as another example, the video signal V1 is a pop-up notification window, and the audio signal A1 is a ringtone. The signal sources are not limited to being distinguished in accordance with physical device or software interface. For example, the first signal source 131 is a television box, and the second signal source 132 is a cellphone of the user. As another example, the first signal source 131 is an audio-video website, and the second signal source 132 is communication software. As yet another example, the first signal source 131 is a first website address of an audio-video website, and the second signal source 132 is a second website address of the audio-video website.

A communication interface adopted by signal sources of a physical device may be an Ethernet interface, a line-in cable/port, a serial bus, a digital visual interface (DVI), a video graphics array (VGA), a musical instrument digital interface (MIDI), a USB-A (universal serial bus type-A), a USB-B, a USB-C, a micro USB, a mini USB, a USB 2.0, a USB 3.0, a Lightning, an HDMI-A (high-definition multimedia interface type-A), an HDMI-B, an HDMI-C, an HDMI-D, or a DisplayPort (DP). The multiple-audio-source adaptive switching device 11 may comprise one or several input ports of the communication interface. The signal sources of the software interface may be a website tab, an application program, or a foreground/background program.

In this embodiment, the playing device 12 comprises an audio receiver 121 and a video receiver 122. The audio receiver 121 is coupled to an audio detector 112, and the video receiver 122 is coupled to a video sender 113. The playing device 12 may be a display system which comprises a screen and a speaker, and the speaker may be independent from or integrated with the screen. In some embodiments, the playing device 12 may distinguish the user interface into a plurality of sub-interfaces, such as windows, tabs, picture-by-picture (PBP), picture-in-picture (PIP), OSD, or split pictures in accordance with multi-task processing (MTP), and each of the sub-interfaces may correspond to a corresponding one of the signal sources. Details would be explained later.

In this embodiment, the multiple-audio-source adaptive switching device 11 comprises a multiplexer 111, the audio detector 112, and the video sender 113. The multiplexer 111 is coupled to the audio detector 112, and the audio detector 112 is coupled to the video sender 113. The multiplexer 111 is configured to receive a plurality of audio signals, such as the audio signals A1, A2, A3, and output one audio signal among the audio signals A1, A2, A3 to the audio receiver 121 of the playing device 12. The signal sources may be digital signal sources or analog signal sources, respectively. In some embodiments, the multiple-audio-source adaptive switching device 11 may comprise a line-in port to receive an external audio source. In addition, the multiple-audio-source adaptive switching device 11 may further comprise an analog-digital converter (not shown in the drawings) which is coupled between the signal sources and the multiplexer 111 or coupled between the multiplexer 111 and the audio detector 112. In some embodiments, the multiplexer 111 may cyclically switch in an extraction range defined by the plurality of signal sources to receive the audio signals A1, A2, A3. For example, the first signal source 131, a third signal source (not shown in the drawings), and a sixth signal source (not shown in the drawings) synchronously send out the audio signals, and the multiplexer 111 switches to the first signal source 131 at a first time point, switches to the third signal source at a second time point, switches to the sixth signal source at a third time point, switches to the first signal source 131 at a fourth time point, and so on.

The audio detector 112 may be configured to execute a multiple-audio-source adaptive switching method of one or some embodiments of the instant disclosure. The video sender 113 is configured to receive a plurality of video signals, such as the video signals V1, V2, V3, and output one or a plurality of video signals V1, V2, V3 to the video receiver 122 of the playing device 12. The audio detector 112 and the video sender 113 may be implemented using an integrated or independent processor. The processor may adopt an SoC chip, a central processing unit (CPU), a micro-control unit (MCU), an application specific integrated circuit (ASIC), a field programmable gate array (FPGA) or a logic circuit.

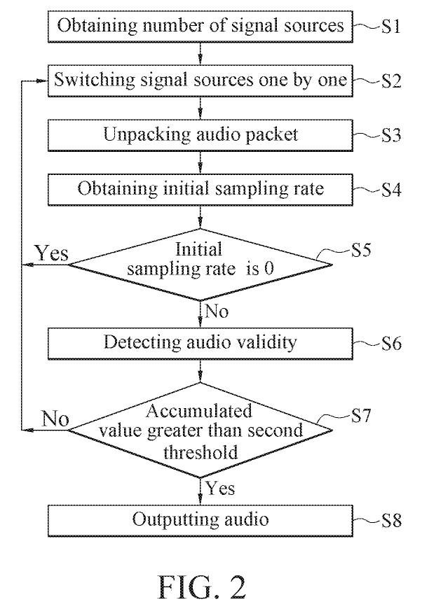

FIG. 2 illustrates a flow chart of the multiple-audio-source adaptive switching method according to some embodiments. In order to facilitate the understanding of possible operations of the audio detector 112 and the video sender 113, FIG. 2 shows one of the embodiments of the multiple-audio-source adaptive switching method (hereinafter abbreviated as “switching method”). It should be noted that, without departing from the spirit and scope of the instant disclosure, performing changes, omission, and refinement on the flow chart of each of the embodiments to obtain another arrangement can be expected.

In this embodiment, the switching method obtains the number of the signal sources (step S1) and switches the signal sources one by one (step S2). In some embodiments, the video sender 113 receives a plurality of video signals V1, V2, V3, and defines a range and the number of the signal sources in accordance with the sources of the received video signals V1, V2, V3. For example, in the case that the video sender 113 merely receives the video signal V1 and the video signal V2 and does not receive the video signal V3, the video sender 113 determines that the extraction range of the signal sources is the first signal source 131 and the second signal source 132 and that the number of the signal sources is 2. Based on that each of the video signals V1, V2 corresponds to the corresponding one of the audio signals A1, A2, when the existence states of the video signals V1, V2 are confirmed, the extraction range of the audio signals A1, A2 is also defined. In this embodiment, the video sender 113 may send the extraction range to the audio detector 112; the audio detector 112 may arrange the audio signals within the extraction range, and the audio detector 112 may control the multiplexer 111 to cyclically switch within the extraction range to receive a plurality of audio signals. Therefore, the audio detector 112 may control the multiplexer 111 to cyclically switch within the extraction range covering the audio signal A1 and the audio signal A2, regardless of whether an output state of the audio signal A1 and/or the audio signal A2 is valid or invalid when the switching method determines that the video signals V1, V2 exist. In some other embodiments, the multiplexer 111 may also switch between all audio input terminals of the multiple-audio-source adaptive switching device 11 (such as the audio input terminals of the audio signals A1, A2, A3 shown in FIG. 1), and thus the step S1 may be omitted. The switching method may determine the existence states of the video signal V1, V2, V3 in accordance with a voltage variation of the signal pin of the video input terminal, a hot plug detect (HPD) signal, a request signal sent by the signal terminal, or a clock signal.

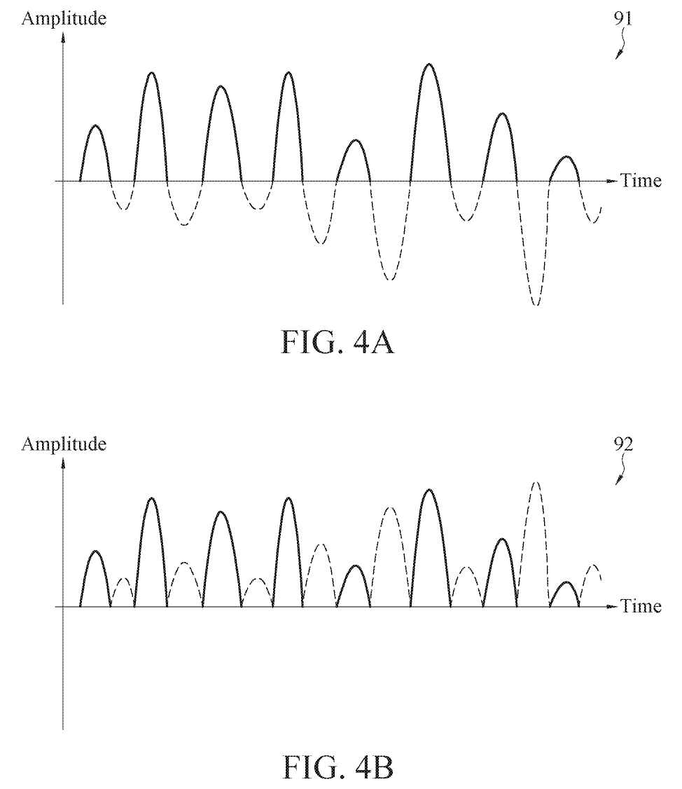

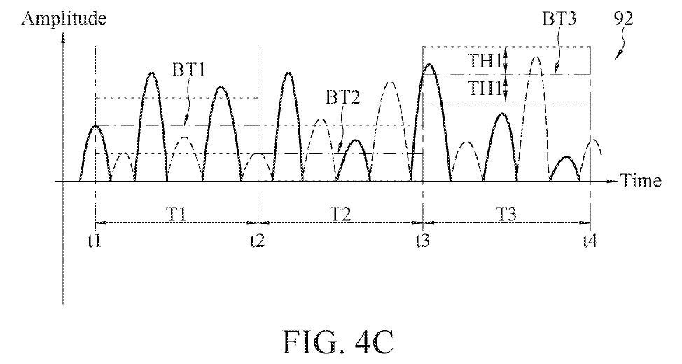

In the step S3, the switching method unpacks an audio packet. In some embodiments, the audio detector 112 may perform unpacking of the audio signals A1, A2, A3 in accordance with a communication interface protocol to which the signal sources correspond, to obtain numerical data of the audio signals A1, A2, A3. In addition to the numerical data, the packet may also comprise sampling rates, compression rates, the number of channels, serial numbers, synchronization bits, a mute state, or an encoding format. For example, settings are performed on the audio format in accordance with a digital audio interface requirement of IEC60958. In some other embodiments, the audio signals are analog signals, and the step S3 may be omitted. FIG. 4A is an oscillogram of temporal data of the audio signal according to some embodiments. Please also refer to FIG. 2 and FIG. 4A. FIG. 4A shows the temporal data of the audio signals A1, A2, A3, where the horizontal axis represents time, and the vertical axis represents an amplitude (voltage or data point) of the temporal data 91. In some embodiments, the switching method may obtain the initial sampling rate through reading the sampling rate of the numerical data within the packet (step S4). In some other embodiments, the switching method may obtain the initial sampling rate through detecting the temporal data 91 (step S4). For example, the audio detector 112 may execute audio frequency detection (AFD) to determine the frequency components of the numerical data to estimate the initial sampling rate. After the AFD confirms the number of channels of the current audio signals (such as two channels or multiple channels), the number of packets received within a unit time is calculated to estimate the initial sampling rate. In some other embodiments, the estimation method of the initial sampling rate may also adopt Fast Fourier Transform (FFT), band-pass filtering, or autocorrelation analysis to obtain the initial sampling rate of the numerical data. For example, the audio detector 112 executes the FFT on the numerical data to be detected to obtain a peak frequency, finds a product of the peak frequency and the number of FFT sampling points, and estimates the initial sampling rate with an integer as the divisor. In some other embodiments, the multiple-audio-source adaptive switching device 11 adopts an analog digital converter to sample the analog audio signals, and the switching method obtains the initial sampling rate in accordance with sampling rate settings of the analog digital converter (step S4).

In the step S5, the switching method determines whether the initial sampling rate is 0. For example, in response to that the audio outputs of the signal sources are not connected to the audio input terminal of the multiple-audio-source adaptive switching device 11, or the audio sources of the signal sources are broken, or the signal sources merely have the video sources, the audio detector 112 determines that the initial sampling rate should be 0. In response to that the switching method determines that the initial sampling rate is 0 (step S5, determined as “yes”), the switching method returns to the step S2 to switch to a next signal source within the extraction range and executes the step S2 to the step S5 on a next one of the audio signals A1, A2, A3. In some other embodiments, in response to that a determination of the step S5 is “yes”, the audio detector 112 notifies the video sender 113 to obtain the number of the signal sources again (step S1) to once again define the extraction range. In response to that the switching method determines that the initial sampling rate is not 0 (step S5, determined as “no”), the switching method detects an audio validity (step S6).

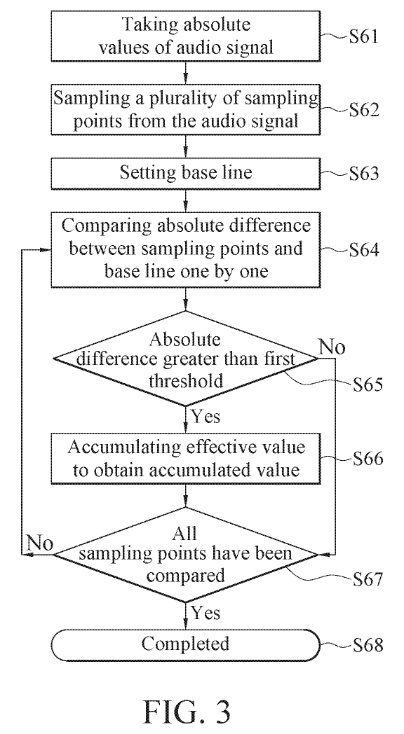

FIG. 3 illustrates a flow chart of steps for detecting the audio validity of the multiple-audio-source adaptive switching method according to some embodiments; FIG. 4B illustrates an oscillogram of temporal data of the audio signal according to some embodiments after taking absolute value. Please also refer to FIG. 3, FIG. 4A, and FIG. 4B. In the step S61, the switching method takes the absolute value of the audio signal. For example, 2’s complement processing is performed on the numerical data whose sign bit is 1. FIG. 4A and FIG. 4B show the numerical data whose initial values are negative using broken lines. The temporal data 91 of FIG. 4A, after being taken the absolute value, is shown by the temporal data 92 of FIG. 4B. In this embodiment, the peak values of the temporal data 92 are all positive numbers, and therefore the audio detector 112 can easily compare a relative strength of each of the data points of the temporal data 92.

FIG. 4C illustrates an oscillogram of temporal data to be sampled of the audio signal according to some embodiments. Please also refer to FIG. 3 and FIG. 4C. The switching method samples a plurality of sampling points from the audio signal (step S62), where the switching method samples a group of the sampling points for the temporal data 92 within a sampling range T1, samples another group of the sampling points within a sampling range T2, and samples yet another group of the sampling points within a sampling range T3. A starting point of the sampling range T1 is a time point t1, a starting point of the sampling range T2 is a time point t2, a starting point of the sampling range T3 is a time point t3, and the sampling manner after the time point t4 can be inferred accordingly. In this embodiment, an ending point of the sampling range T1 and the starting point of the sampling range T2 are the same, i.e., time point t1. In some other embodiments, the ending point of the sampling range T1 and the starting point of the sampling range T2 may be different, i.e., a time gap may exist between each of the sampling ranges. The sampling range may be a moving time window to sample a plurality of sampling points within similar time ranges. In some embodiments, the temporal data 92 itself is a digital signal comprising a plurality of sampling points, and the switching method samples all of the sampling points within the sampling range T1. For example, in response to that the initial sampling rate of the temporal data 92 is 48kHz, the sampling ranges T1, T2, T3 are each 20 ms, and the switching method may capture 960 sampling points within the sampling range T1. In other words, in some embodiments, the sampling rate of the audio detector 112 may be set to less than or equal to the initial sampling rate of the temporal data 92.

Afterwards, the switching method sets a base line (step S63). In the embodiment shown in FIG. 4C, the switching method samples 256 sampling points within the sampling range T1 and selects an amplitude of one sampling point (hereinafter referred to as a “first sampling point”) among the 256 sampling points as the amplitude of the base line. In this embodiment, the switching method takes the starting point of each of the sampling ranges as the first sampling point, and therefore the amplitude of the temporal data 92 at the time point t1 is set as the base line BT1, the amplitude of the temporal data 92 at the time point t2 is set as the base line BT2, and the amplitude of the temporal data 92 at the time point t3 is set as the base line BT3. In other embodiments, any one of the sampling points within the sampling range T1 may serve as the first sampling point. As shown in FIG. 4C, the amplitude of the base lines BT1, BT2, BT3 may fluctuate, depending on the amplitude of the first sampling point.

In the step S64, the switching method compares the absolute difference between the sampling points and the base lines one-by-one. For example, among the 256 sampling points within the sampling range T1, one sampling point is assigned as the first sampling point, and an absolute difference is taken between each of the amplitudes of the remaining 255 sampling points (hereinafter referred to as “the second sampling points”) and the amplitude of the first sampling point, i.e., subtracted and then taken the absolute value. Afterwards, the switching method determines whether the absolute difference is greater than a first threshold value TH1 (step S65). When the switching method determines that the absolute difference between any one of the second sampling points and the first sampling point is less than the first threshold value TH1, this indicates that this second sampling point is invalid. The first threshold value TH1 reflects an acceptable variation between the sampling points of the temporal data 92; to be more precise, the first threshold value TH1 reflects the acceptable variation of the absolute difference between the second sampling points and the first sampling point. As shown in FIG. 4C, broken lines are drawn on the upper and lower sides of the base lines BT1, BT2, BT3, and the distance between each of the broke lines and each of the base lines BT1, BT2, BT3 is the first threshold value TH1. For example, the signal source may still output the temporal data 92 whose amplitude is 0 under the mute mode. In this case, the temporal data is still sampled with the default initial sampling rate. As a result, the determination of the step S5 is “no.” However, the audio signals A1, A2, A3 may still be determined as invalid audio signal. The first threshold value TH1 may be defined in accordance with the acceptable variation of the amplitude of an invalid audio signal or defined in accordance with a minimum variation of the amplitude of the valid audio signal.

In response to that the switching method determines that the absolute difference is greater than the first threshold value TH1 (step S65, determined as “yes”), the switching method accumulates the effective value to obtain an accumulated value (step S66). For example, the amplitude of the first sampling point is 60, the amplitudes which come after the second sampling point are sequentially [57, 32, 72, 8, 66, 105], the first threshold value TH1 is 10, and therefore the accumulated values which come after the second sampling point are sequentially [0, 1,2,3,3,4]. Here, the accumulated value 4 indicates that among the 6 second sampling points, 4 second sampling points are valid. In this embodiment, the accumulated values refer to valid integer values. In some other embodiments, the accumulated values refer to valid fraction values, whose numerator and denominator may be respectively accumulated. For example, the accumulated values may refer to ratios of the valid second sampling points to the invalid second sampling points within the sampling ranges T1, T2, T3, and therefore the accumulated value are sequentially [0/1, 1/1, 2/1, 3/1, 3/2, 4/2], i.e., [0, 1, 2, 3, 1.5, 2]. As another example, the accumulated values may refer to ratios of the valid second sampling points to all of the sampling points within the sampling ranges T1, T2, T3, and therefore the accumulated values are sequentially [0/256, 1/256, 2/256, 3/256, 3/256, 4/256].

In response to that accumulation of the effective values (step S66) is completed, or in response to that the switching method determines that the absolute difference is not greater than the first threshold value TH1 (step S65, determined are “no”), the switching method determines whether all of the sampling points have been compared (step S67). In response to that the switching method determines that all of the sampling points have not been compared (step S67, determined as “no”), the switching method returns to the step S64 to compare the next second sampling point; in response to that the switching method determines that all of the sampling points have been compared (step S67, determined as “yes”), the process of detecting audio validity is completed (step S68).

Based on the accumulated values generated in the step S6, the switching method determines whether the accumulated values are greater than the second threshold value (step S7). In this embodiment, in response to that the switching method determines that the accumulated values are not greater than the second threshold value (step S7, determined as “no”), the switching method returns to the step S2 to switch to a next signal source within the extraction range, and the switching method executes the step S2 to the step S7 on a next one of the audio signals A1, A2, A3. In some other embodiments, in response to that the step S7 determines “no,” the audio detector 112 notifies the video sender 113 to obtain the number of the signal sources (step S1) again to once again define the extraction range. In response to that the switching method determines that the accumulated value is greater than the second threshold value (step S7, determined as “yes”), the switching method outputs audio signal (step S8). The second threshold value may reflect the tolerance of the number of valid or invalid sampling points within the sampling ranges T1, T2, T3.

The following illustrates possible applications of the multiple-audio-source adaptive switching system 10 in accordance with different embodiments. It should be noted that, without departing from the spirit and scope of the instant disclosure, other application scenarios which perform changes, replacement, repurposing, and simplification on the possible applications of each of the embodiments can be expected.

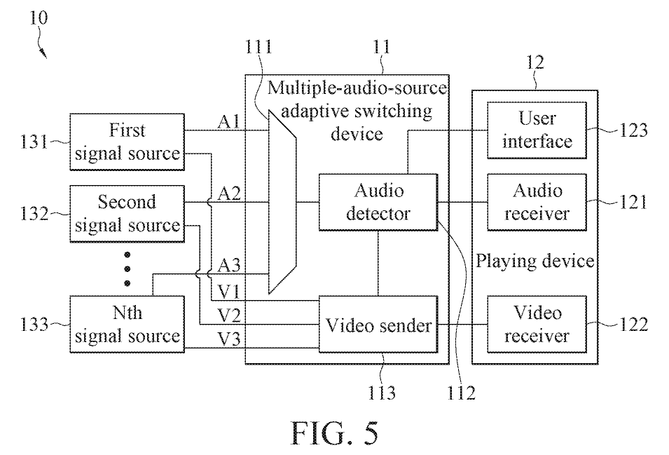

Please refer to FIG. 1. In some embodiments, the playing device 12 executes a PBP mode, the user watches the video through the first picture, and background programs of the second picture comprise communication software. Therefore, the first signal source 131 corresponds to the first picture (the video signal V1 and the audio signal A1 may come from an audio-video website), and the second signal source 132 corresponds to the second picture (the video signal V2 and the audio signal A2 may come from the communication software or another foreground/background program). At this time, the communication software of the second picture suddenly pops up an incoming call notification, and the audio detector 112 detects that the audio signal A2 of the second picture is valid and therefore outputs the audio signal A2 of the second picture to the playing device 12. FIG. 5 illustrates a block diagram of the multiple-audio-source adaptive switching system according to some other embodiments. Please refer to FIG. 5. The playing device 12 comprises an audio receiver 121, a video receiver 122, and a user interface 123. The audio detector 112 is coupled to the user interface 123 to be able to receive user control signals or send user notification signals. In this embodiment, the audio detector 112 may determine whether to output the audio signal A2 of the second picture to the playing device 12 in response to a logical value (choosing/choosing not answering the incoming call) of the user control signal. In another embodiment, the audio detector 112 detects that the audio signal A2 of the second picture is valid and therefore sends the user notification signal to the user interface 123, the playing device 12 generates a pop-up notification window, and the audio detector 112 may determine whether to output the audio signal A2 of the second picture to the playing device 12 in response to a logical value (switching/not switching audio source) generated from the user clicking the notification window.

In some embodiments, the user watches a video through the first picture in the PBP mode and uses the communication software through the second picture to make a phone call. When the phone call of the second picture ends, the audio detector 112 detects that the accumulated values of the audio signal A2 of the second picture are switched to being less than the second threshold value. In this embodiment, in response to that the audio detector 112 determines that the audio signal A2 which is currently being outputted is invalid, the audio detector 112 once again executes the switching method (for example the step S1 to the step S8, or the step S2 to the step S8). At this time, the audio detector 112 detects that the audio signal A1 of the first picture is valid and therefore outputs the audio signal A1 of the first picture to the playing device 12. Similarly, the audio detector 112 may determine whether to output the audio signal A1 of the first picture to the playing device 12 in response to the logical value (switching/not switching the audio source) of the user control signal. Alternatively, in another embodiment, the audio detector 112 may determine whether to output the audio signal A1 of the first picture to the playing device 12 in response to a selection value (selecting the first picture/the second picture; for example, a cursor clicks on or moves to a picture) of the user control signals.

Please refer to FIG. 1. In some embodiments, the playing device 12 operates in the PIP mode, the user watches a first video through a primary picture and watches a second video through a secondary picture. Therefore, the first signal source 131 corresponds to the primary picture (the video signal V1 and the audio signal A1 may come from a first URL of the audio-video website), and the second signal source 132 corresponds to the secondary picture (the video signal V2 and the audio signal A2 may come from a second URL of the audio-video website). At this time, the user enlarges the secondary picture through the user interface 123 to replace the primary picture, and the multiple-audio-source adaptive switching device 11 receives the control command to terminate receiving the first signal source 131. At this time, the audio detector 112 detects that the audio signal A1 of the first signal source 131 is invalid and may once again execute the switching method.

In some embodiments, the plurality of audio signals within the extraction range A1, A2, A3 comprise the primary audio signal and the secondary audio signal. In response to that the accumulated values of the primary audio signal are determined to be greater than the second threshold value during outputting of the secondary audio signal, the primary audio signal is outputted. For example, in the PIP mode, the primary picture corresponds to the primary audio signal, and the secondary picture corresponds to the secondary audio signal. At this time, the audio detector 112 detects that the accumulated values of the primary audio signal and the accumulated values of the secondary audio signal are both greater than the second threshold value and outputs the primary audio signal. At this time, in response to that the audio detector 112 determines that the accumulated values of the primary audio signal are switched to being less than the second threshold value (for example, the user mutes the primary picture), the audio detector 112 once again executes the switching method. In response to that the audio detector 112 determines that the accumulated values of the secondary audio signal are greater than the second threshold value, the outputted audio signal is switched from the primary audio signal to the secondary audio signal. In some embodiments, the audio detector 112 continuously executes the switching method during the outputting of the audio signals A1, A2, A3. In response to that the accumulated values of the primary audio signal are determined to have been switched to being greater than the second threshold value (for example, the user unmutes the primary picture), the outputs audio signal is switched from the secondary audio signal to the primary audio signal.

In some embodiments, the primary audio signal is defined in accordance with the selection signal. For example, the user controls the cursor to click or move to a picture corresponding to one of the video signals V1, V2, V3 through the user interface 123 to generate the selection value. The user interface 123 generates a control signal comprising the selection value and sends the control signal to the audio detector 112. The audio detector 112 may define the audio signals A1, A2, A3 corresponding to the control signal as the primary audio signal in response to the selection value of the user control signal; alternatively, in some embodiments, the user assigns the audio signals A1, A2, A3 generated by any one of the signal sources as the primary audio signal through the user interface 123 and sends the control signal comprising the selection value to the audio detector 112. In some embodiments, the primary audio signal is defined in accordance with the input terminal of the multiple-audio-source adaptive switching device 11. For example, the multiple-audio-source adaptive switching device 11 may comprise a plurality of digital input terminals and an external line-in port input terminal, the audio signal A1, A2, A3 received by the external line-in port input terminal may be defined as the primary audio signal, and the rest of the digital input terminals are defined as the secondary audio signals. Alternatively, in some embodiments, the multiple-audio-source adaptive switching device 11 comprises a plurality of digital input terminals, and the audio signal A1, A2, A3 received by any one of the digital input terminals may be defined as the primary audio signal.

Although the instant disclosure has been disclosed using the exemplary embodiments above, the exemplary embodiments are not meant to limit the instant disclosure. Any alteration and retouch made by persons skilled in the art without deviating from the spirit of the instant disclosure shall fall into the scope of the instant disclosure. The scope of protected invention shall be defined by the claims below.

What is claimed is:

1. A multiple-audio-source adaptive switching method comprising:
receiving an audio signal;
sampling a plurality of sampling points from the audio signal, wherein one of the sampling points is defined as a first sampling point, and rest of the sampling points are defined as a plurality of second sampling points;
accumulating an effective value in response to that an absolute difference between each of the second sampling points and the first sampling point is determined to be greater than a first threshold value to obtain an accumulated value; and
outputting the audio signal in response to that the accumulated value is determined to be greater than a second threshold value.

2. The multiple-audio-source adaptive switching method according to claim 1, further comprising receiving a plurality of the audio signals, wherein the audio signals comprise a primary audio signal and a secondary audio signal, and in response to that the accumulated value of the primary audio signal is determined to be greater than the second threshold value during outputting of the secondary audio signal, outputting the primary audio signal.

3. The multiple-audio-source adaptive switching method according to claim 2, further comprising:
receiving a plurality of video signals, wherein each of the video signals corresponds to a corresponding one of the audio signals;
receiving a selection signal, wherein the selection signal assigns one of the video signals comprised in the video signals; and
defining the primary audio signal in accordance with the audio signal corresponding to the one of the video signals.

4. The multiple-audio-source adaptive switching method according to claim 1, further comprising:
receiving a plurality of the audio signals; and
in response to that the accumulated value of the one of the audio signals is determined to be less than the second threshold value during outputting of one of the audio signals, receiving another one of the audio signals and determining the effective value of the another one of the audio signals.

5. The multiple-audio-source adaptive switching method according to claim 4, further comprising:
receiving a plurality of video signals, wherein each of the video signals corresponds to a corresponding one of the audio signals;
defining an existence state of each of the audio signals in accordance with the corresponding one of the video signals to define an extraction range of the audio signals; and
cyclically switching in the extraction range to receive the audio signals.

6. The multiple-audio-source adaptive switching method according to claim 1, further comprising:
receiving a plurality of the audio signals;
detecting an initial sampling rate of each of the audio signals; and
in response to that the initial sampling rate of one of the audio signals is determined to be zero, receiving another one of the audio signals and determining the initial sampling rate of the another one of the audio signals.

7. The multiple-audio-source adaptive switching method according to claim 1, further comprising sampling the sampling points from the audio signal in accordance with a movement time window, wherein a first one of the sampling points is defined as the first sampling point, and the rest of the sampling points are defined as the second sampling points.

8. A multiple-audio-source adaptive switching device comprising:
a multiplexer configured to receive a plurality of audio signals and output one of the audio signals; and
an audio detector configured to:
receive the one of the audio signals;
sample a plurality of sampling points from the one of the audio signals, wherein one of the sampling points is defined as a first sampling point, and rest of the sampling points are defined as a plurality of second sampling points;
accumulate an effective value in response to that an absolute difference between each of the second sampling points and the first sampling point is determined to be greater than a first threshold value to obtain an accumulated value; and
output the one of the audio signals in response to that the accumulated value is determined to be greater than a second threshold value.

9. The multiple-audio-source adaptive switching device according to claim 8, further comprising:
a video sender configured to:
receive a plurality of video signals, wherein each of the video signals corresponds to a corresponding one of the audio signals;
define an existence state of each of the audio signals in accordance with the corresponding one of the video signals to define an extraction range of the audio signals; and
send the extraction range to the audio detector, wherein
the audio detector is further configured to:
cyclically switch in the extraction range to receive the audio signals.

10. The multiple-audio-source adaptive switching device according to claim 8, further comprising:
a user interface configured to receive a selection signal;
a video sender configured to:
receive a plurality of video signals, wherein each of the video signals corresponds to a corresponding one of the audio signals;
receive the selection signal, wherein the selection signal assigns one of the video signals comprised in the video signals;
define a primary audio mark for the audio signal corresponding to the one of the video signals; and
send the primary audio mark to the audio detector, wherein
the audio detector is further configured to:
define a primary audio signal and a secondary audio signal different from the primary audio signal in accordance with the primary audio mark among the audio signals; and
in response to that the effective value of the primary audio signal is determined to be greater than the second threshold value during outputting of the secondary audio signal, output the primary audio signal.
